(19) United States
(12) Patent Application Publication
(10) Pub. No.: US 2013/0091974 A1
(43) Pub. Date: Apr. 18, 2013

(54) ARTICULATED INFLATABLE STRUCTURE AND ROBOT ARM COMPRISING SUCH A STRUCTURE

(71) Applicants: Alain Riwan, Chevilly-Larue (FR); Sebastien Voisembert, Versailles (FR)

(72) Inventors: Alain Riwan, Chevilly-Larue (FR); Sebastien Voisembert, Versailles (FR)

(73) Assignee: COMMISSARIAT A L'ENERGIE ATOMIQUE ET AUX ENERGIES ALTERNATIVES, Paris (FR)

(21) Appl. No.: 13/700,945

(22) PCT Filed: May 31, 2011
(86) PCT No.: PCT/EP2011/058979

§ 371 Date: Nov. 29, 2012

Related U.S. Application Data
(60) Provisional application No. 61/439,172, filed on Feb. 3, 2011.

(30) Foreign Application Priority Data
May 31, 2010 (FR) 1054197

(51) Int. Cl. B25J 18/06

(52) U.S. Cl. CPC B25J 18/06; Y10S 901/22; Y10S 901/23; Y10S 901/27; Y10S 901/21
USPC 74/490.04; 901/22; 901/23; 901/27; 901/21

(57) ABSTRACT

An articulated structure having a tubular inflatable casing that contains a fluid under pressure and that has a central axis along which there are defined at least one fixed-geometry segment and at least one variable-geometry segment, the arm including a deformation mechanism for deforming the variable-geometry segment, the casing and the deformation mechanism arranged so as to generate curvature of the variable-geometry segment in such a manner that the variable-geometry segment conserves a volume that is substantially constant. A robot arm including such a structure.

### CROSS REFERENCE TO RELATED APPLICATIONS

This application is a National Stage of International Application No. PCT/EP2011/058979, filed on May 31, 2011, which claims priority from French Patent Application No. 1054197, filed on May 31, 2010, which claims priority from U.S. Provisional Application 61/439,172 filed Feb. 3, 2011, the contents of all of which are incorporated herein by reference in their entirety.

### FIELD OF THE INVENTION

The present invention provides an inflatable articulated structure, and a robot arm including such a structure. The present invention thus provides, for example, a robot arm having a high slenderness ratio designed in particular for inspecting sites that are obstructed, difficult to access, or hostile for humans, in particular because of chemical or radiological risks.

The invention relates more particularly to an arm having an inflatable structure.

### BACKGROUND OF THE INVENTION

Rigid inflatable structures are known that present the advantages of being lightweight, easy to deploy and to stow away, that can accommodate a high slenderness ratio, and that are relatively insensitive to impacts. It has been envisaged to use such a structure in a robot arm in order to enable said arm to benefit from the advantages of inflatable structures.

Such an arm thus generally comprises at least one inflated and rigid segment that is connected to a base and/or to another inflated and rigid segment by a hinge comprising solid mechanical parts implementing pivot connections, slideway connections, and/or sliding pivot connections. The most advanced arms comprise a plurality of inflated and rigid segments that are connected together in pairs by respective hinges.

A drawback of those arms lies mainly in their weight, for which the hinges are mainly responsible. That relatively large weight imposes a limitation on the maximum slenderness of such arms.

### OBJECT AND SUMMARY OF THE INVENTION

An object of the invention is to overcome all or some of the drawbacks of inflatable structures designed to allow angular movements.

To this end, the invention provides an articulated structure comprising a tubular inflatable casing that contains a fluid under pressure and that has at least one variable-geometry segment, the structure including deformation means for deforming the variable-geometry segment, wherein the casing and the deformation means are arranged so as to generate curvature of the variable-geometry segment in such a manner that the variable-geometry segment conserves a volume that is substantially constant. The deformation means comprise at least one actuator associated with at least one cable having an end connected to a portion of the articulated structure in such a manner that traction on the cable gives rise to curving of the variable-geometry segment.

Thus, the articulated structure comprises a hinge constituted by the variable-geometry segment that curves at constant volume, and that limits the energy necessary for modifying its shape. The variable-geometry segment substantially retains relatively good capacity for withstanding forces outside the deformation plane and the deformation means are then of simple structure.

Advantageously, the structure includes a plurality of actuators grouped together on a stand of the structure.

The grouping together of actuators on the stand makes it possible to conserve maximum lightness for the movable portion of the structure.

In a particular embodiment, the casing presents folds at the variable-geometry segment that are substantially perpendicular to the central axis of the casing so as to allow the variable-geometry segment to have a length differential on either side of the central axis while keeping the cross-section of the variable-geometry segment constant.

The variable-geometry segment is thus of simple structure. Keeping the cross-section constant ensures that its volume is conserved.

Thus preferably, the folds are of annular shape and comprise portions that are stitched together along two lines of stitching that extend symmetrically on either side of the central axis, and free portions extending symmetrically on either side of the central axis.

By preventing the unfolding of the folds along two symmetrically opposite lines, the stitching makes it possible together with the central axis to define a median surface of the casing along which the casing has a length that is constant whatever the shape of the variable-geometry segment. Between them, the lines of stitching leave portions that are free to be deformed so as to allow the casing to shorten or lengthen in a plane perpendicular to said median surface.

Advantageously, the deformation means are arranged in order to obtain uniform folding for all of the folds forming said segment.

This makes it possible to obtain regular curvature.

In a particular embodiment, the end of the cable is connected to a free portion of a fold in such a manner that traction exerted by the actuator on the cable causes folding of the fold portion to which the cable is connected.

Preferably, a cable is connected to each fold, the cables having ends connected to rings fastened to the free portions of the folds and at least one of the cables is engaged in two adjacent rings in order to form a pulley system and, advantageously, the variable-geometry segment has n folds and the deformation means associated with said variable-geometry segment comprise a single actuator connected to n cables, each connected to a respective fold, the fold that is the furthest away from the actuator being connected to the corresponding cable by a k-strand pulley system and each of the other folds being connected to the corresponding cable via a respective pulley system having a number of strands that is incremented by 1 on going from the fold adjacent to a first end of the variable-geometry segment to the fold adjacent to a second end of the variable-geometry segment so as to reach n+k strands for said fold.

It is thus possible to use just one actuator to act on all of the cables necessary for curving a variable-geometry segment. The rings form cable deflection pins and any element that is capable of performing this function may be used.

Preferably, the structure includes at least one device for detecting the curvature of at least one variable-geometry segment and, advantageously, the detection device comprises at least an optical fiber extending parallel to a mean line of the variable-geometry segment and having one end connected to a transmitter that transmits a light beam and an opposite end connected to a photodetector connected to a measurement unit for measuring at least one characteristic of the light beam.

This makes it possible to measure the curvature of the variable-geometry segment in real time and to monitor and control the deformation of the structure so as to make it a portion of a robot.

Preferably, the casing presents a central axis along which there are defined at least one fixed-geometry segment and the variable-geometry segment.

The variable-geometry segment and the fixed-geometry segment have substantially the same capacity for withstanding forces outside the deformation plane so that the variable-geometry segment does not affect the overall stiffness of the articulated structure.

According to a particular characteristic, the variable-geometry segment includes at least one bifurcation.

In this way, a multi-branched structure may be made having branches that are hinged to one another.

Advantageously then, the fixed-geometry segment forms a closed loop.

A loop is thus formed to constitute an inflated steerable platform such as a “Stewart” platform.

The invention also provides a robot arm using at least one such articulated inflatable structure.

### BRIEF DESCRIPTION OF THE DRAWINGS

Other characteristics and advantages of the invention appear on reading the following description of particular, non-limiting embodiments of the invention.

Reference is made to the accompanying drawings, in which:

FIG. 1 is a diagrammatic fragmentary perspective view of a robot arm of the invention;

FIG. 2 is a view in perspective and in section along the plane II of FIG. 1 showing a variable-geometry segment of said arm;

FIGS. 3 and 4 are views from above of said segment respectively in a rectilinear shape and in a curved shape;

FIG. 5 is a fragmentary view from above of the arm of FIG. 1, showing the passage of cables and one of the lines of stitching;

FIG. 6 is a fragmentary diagrammatic view from above of a variable-geometry segment of said arm;

FIGS. 7 and 8 are views analogous to the view in FIG. 1 of particular variant embodiments;

FIG. 9 is a fragmentary diagrammatic side view of the robot arm constituting a more advanced version of the first embodiment; and

FIG. 10 is a detail view in perspective of the actuators of a manually operable articulated structure forming a more basic version than that of the invention.

### MORE DETAILED DESCRIPTION

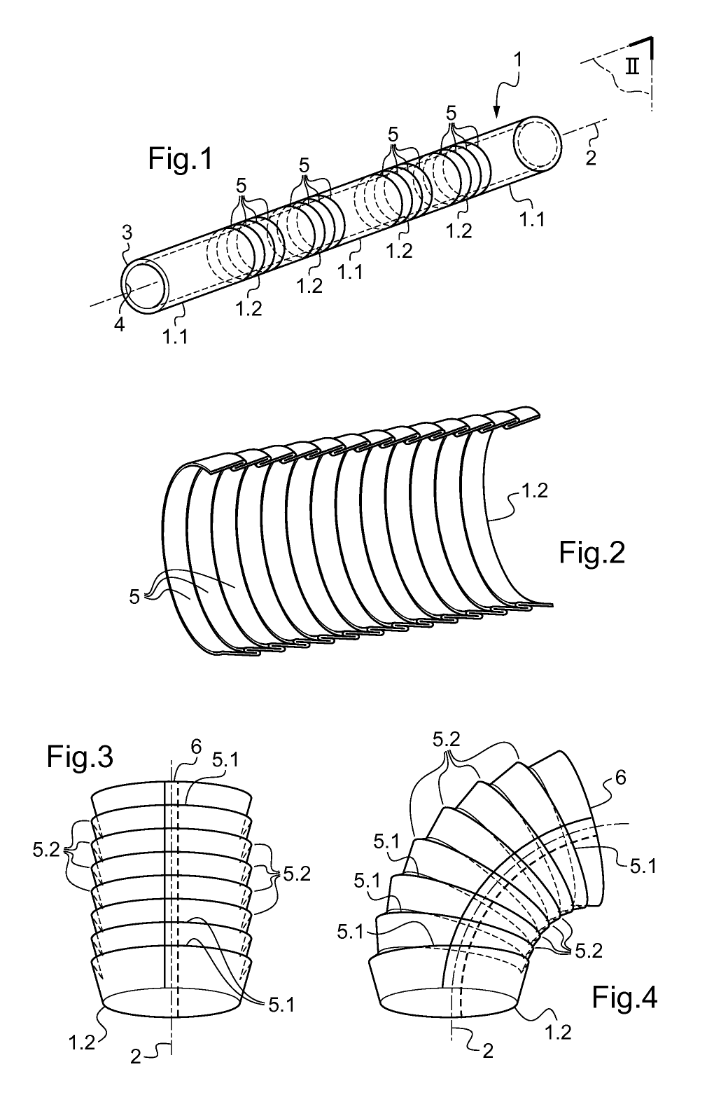

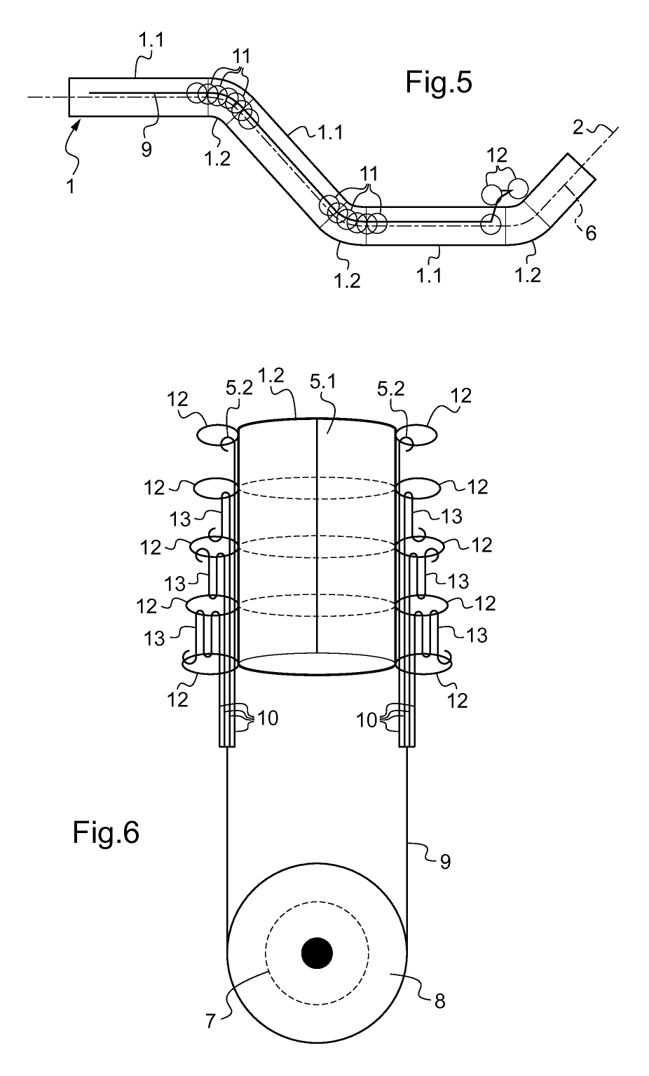

With reference to FIGS. 1 to 6, the robot arm of the invention includes an inflatable structure constituted in this example by a casing, given overall reference 1, and of tubular shape having a central axis 2. Advantageously, the casing 1 comprises an outer fabric 3 covering an inner chamber 4. The fabric 3 is in this embodiment made of a flexible material but is nevertheless substantially inextensible and the chamber 4 is made of an airtight material, in this embodiment an elastomer. The casing 1 has a blocked end and an opposite end provided with admission means for admitting a fluid under pressure, in this embodiment air. The admission means are themselves known and in this embodiment comprise a valve and a pump or a reservoir for fluid under pressure and having an outlet orifice that fits onto the valve. Naturally, other means for inflating the casing may be used.

The casing 1 comprises fixed-geometry segments 1.1 and variable-geometry segments 1.2 that are defined in alternation along the central axis 2. At the segments 1.1, the fabric 3 is taut while at the segments 1.2, the fabric has folds 5. The folds 5 are of annular shape and comprise portions 5.1 that are stitched together along two lines of stitching 6 extending symmetrically on either side of the central axis 2, and free portions 5.2 extending symmetrically on either side of the central axis 2. By using this construction, the lines of stitching 6 ensure that the segment 1.2 is inextensible in two symmetrically opposite longitudinal zones of the casing 1 and the folds 5 allow each segment 1.2 to be curved by allowing a segment length differential on either side of the central axis 2 while keeping a cross-section of the segment 1.2 constant so that the segment 1.2 conserves a volume that is constant whatever its shape. The free portions are arranged so as to allow the segment 1.2 to curve through a maximum angle of not less than about 90°. The maximum angle of curvature of the segment 1.2 depends in particular on its length and it is very easy to obtain different maximum values.

Deformation means are associated with each variable-geometry segment. They are designed to obtain equal folding of each of the folds forming said segment when it is desired to obtain uniform curvature.

For each segment 1.2, the deformation means of the segments 1.2 comprise a position-controlled electric motor 7 having an outlet shaft driving a winding pulley 8 for winding a central portion of a primary cable 9. It should be noted that, as a result of this mounting, when the motor exerts traction on one strand of the primary cable 9 (and therefore on the bundle of secondary cables 10 attached thereto), it releases the other strand of the primary cable 9 (and therefore on the bundle of secondary cables 10 attached thereto). The cable 9 runs along the casing 1 and is guided by guide means 11 (e.g. sheaths or in this example rings 11) that are fastened at regular intervals along the casing 1 and that slidably receive the primary cable 9.

The primary cable 9 has two opposite ends each connected to a bundle of secondary cables 10 extending on either side of the casing 1, substantially facing the free portions 5.2 of the folds 5 of the segment 1.2 in question. Each secondary cable 10 has one end fastened to the primary cable 9 and an opposite end fastened to a ring 12 fastened on the free portion 5.2 of a fold 5 in such a manner that traction exerted by the actuator on the secondary cable 10 causes folding of the free portion 5.2 of the fold 5 to which that secondary cable 10 is connected.

Each segment 1.2 thus includes n folds, and the deformation means associated with said segment 1.2 comprise a single actuator 7 that is connected, for each side of the n-cable segment 1.2, to n secondary cables 10, each connected to a respective deformable portion 5.2 of a fold 5. The deformable portion 5.2 of the fold 5 that is the furthest away from the actuator is connected directly to the corresponding secondary cable 10, and each of the deformable portions 5.2 of the other folds 5 is connected to the secondary cable 10 that corresponds thereto via a pulley system 13 comprising a number of strands that increases from 1 for the fold that is the furthest away from the actuator, up to the fold that is the closest to the actuator where there are n strands for that fold closest to the actuator. FIG. 6 shows a variable-geometry segment comprising a number n of folds that is equal to four.

It should be noted that certain rings 12 slidably receive one or more secondary cables 10.

The admission means and the deformation means are grouped together in a base (not shown), that is used to support the robot, the end of the casing 1 associated with the admission means being fastened to said base.

The casing 1 and the deformation means are arranged to generate curving of the variable-geometry segments 1.2 in such a manner that the variable-geometry segments 1.2 conserve a volume that is constant whatever their curvature.

The folds 5 that are substantially perpendicular to the central axis of the casing allow a length differential to arise on opposite sides of the central axis 2 of a variable-geometry segment, while keeping the cross-section of the segment 1.2 constant.

By using dedicated actuators 7 and without coupling the segments together, it is possible to modify the shape of each section 1.2, regardless of the shape of the other segments.

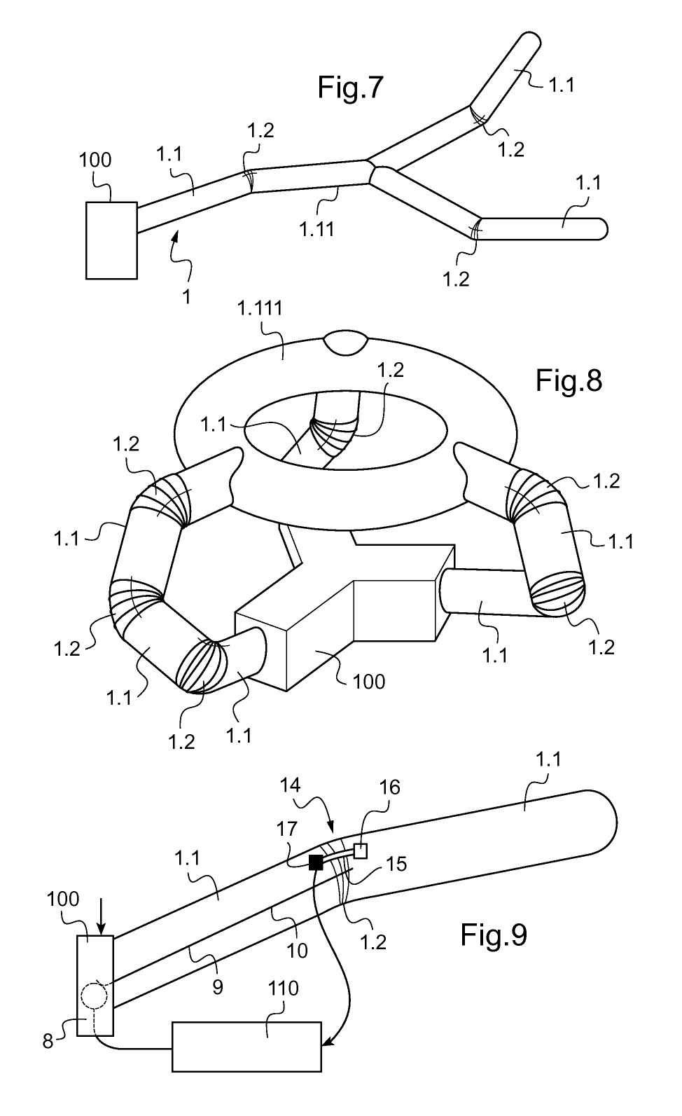

FIG. 7 shows a casing 1, constituted as described above, having an end secured to a stand 100, fixed-geometry segments 1.1 and 1.11, and variable-geometry segments 1.2.

The segments 1.1 and 1.2 are identical to those described above.

The segment 1.11 is Y-shaped having a main branch connected to the stand 100 via a segment 1.2 and a segment 1.1, and two diverging branches, each connected to a segment 1.1 via a segment 1.2.

The structure thus has two diverging branches that are deformable independently of each other by means of actuators and cables as described above.

In a variant, the segment 1.1 may comprise more than two branches.

FIG. 8 shows a structure comprising a steerable platform 1.111.

The structure includes a stand 100 from which three arms project, each arm comprising, from the stand 100 to the platform 1.111: a first segment 1.1, a first segment 1.2, a second segment 1.1, a second segment 1.2, a third segment 1.1, and a third segment 1.2.

The platform 1.111 is formed of an inflated casing portion in communication with the arms.

Preferably, the axes of rotation of the arms are not parallel to one another in order to increase the steering possibilities of the platform.

FIG. 9 shows a structure such as the structure of FIG. 1, having one end connected to a stand 100 and a free opposite end and comprising a segment 1.2 that extends between two segments 1.1 and that is controlled (deformed) by means of cables 9, 10 connected to one or more actuators 8 mounted in the stand 100. In this embodiment, the actuators 9 are electric motors each having an outlet shaft provided with a pulley for winding the cable 9. The electric motors are connected to a control unit 110 in order to be controlled by said unit.

The structure includes a device 14 for detecting the curvature of the segment 1.2.

This device comprises an optical fiber 15 extending parallel to a mean line of the segment 1.2 and having one end connected to a photodetector 17 connected to the control unit 110. The transmitter 16 and the photodetector 17 are each fastened on one of the segments 11 extending on either side of the segment 1.2.

The control unit 110 incorporates a measuring module for measuring the intensity of a light beam identified by the photodetector 17, and it is programmed to control the motors as a function of the measured intensity and of a setpoint.

If there are a plurality of segments 1.2, the same number of devices 14 are provided.

In a variant, it is possible to provide an optical fiber that is shared by a plurality of segments 1.2 in order to measure the curvature of said segments, e.g. as a function of a plurality of characteristics of the light beam (intensity, travel time).

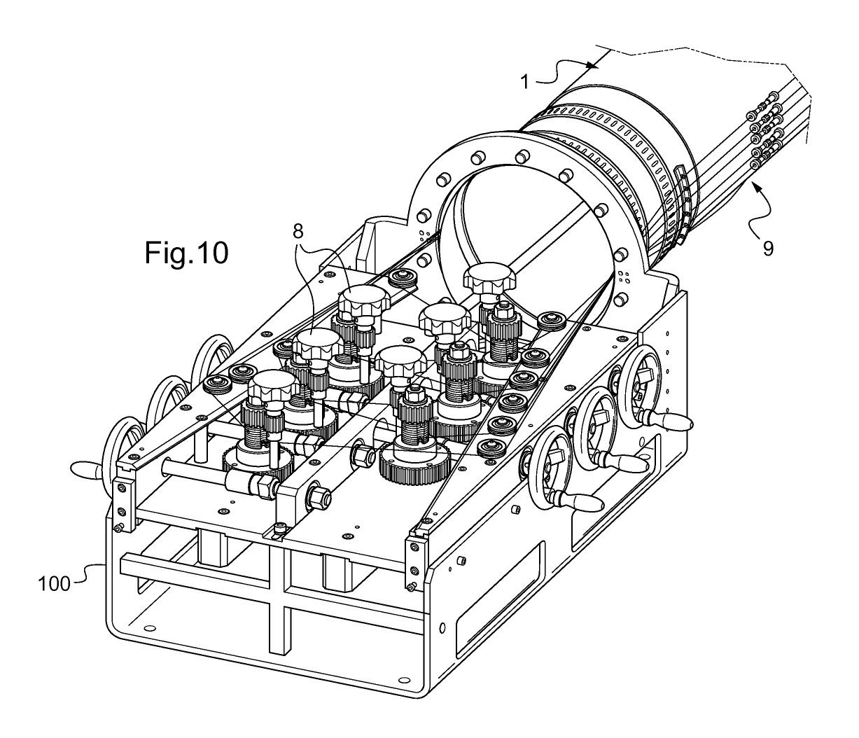

FIG. 10 shows a structure, such as the structure of FIG. 1, comprising a stand 100 in which the actuators 8 are grouped together so as to lighten the movable portion of the structure and thereby enable remote control of the segments 1.2.

Naturally, the invention is not limited to the embodiments described but encompasses any variant coming within the ambit of the invention as defined by the claims.

In particular, the casing may comprise one or more layers that are optionally connected together over their entire surface area. By way of example, the casing may be formed by a coated fabric. The casing may comprise different materials depending on the variable-geometry segments or the portions of variable-geometry segments. The casing may be made of an extensible material along the central axis of the arm so that the variable-geometry segments may be free from folds on condition of guaranteeing inextensibility along the lines 6.

The fluid used to inflate the casing of the robot arm may be air, another gas such as an inert gas, or a liquid.

The deformation means may comprise only one type of cable and as many actuators as cables (without having recourse to pulley systems).

The deformation means may be arranged to allow asymmetrical curving.

In particular, the actuators may be rotary actuators or rectilinear reciprocating motion actuators.

The variable-geometry segments may be arranged to enable a maximum angle of curvature greater than or less than 90°. When said segment has folds, the number and depth of the folds can be controlled.

The rings 11, 12 may be made of any material, metal plastics material, fabric . . . . However, a rigid material is preferred for the rings 12 with which a pulley system is made. Any element providing a deflector axis function may be used in place of the rings. It is thus possible to use pulley wheels proper in order to reduce friction.

The articulated structure need not have any actuators.

The invention may also be obtained by kinematic inversion of the deformation means described above.

1. An articulated structure comprising a tubular inflatable casing that contains a fluid under pressure and that has at least one variable-geometry segment, the structure including deformation means for deforming the variable-geometry segment, wherein the casing and the deformation means are arranged so as to generate curvature of the variable-geometry segment in such a manner that the variable-geometry segment conserves a volume that is substantially constant, and wherein the deformation means comprise at least one actuator associated with at least one cable having an end connected to a portion of the articulated structure in such a manner that traction on the cable gives rise to curving of the variable-geometry segment.

2. A structure according to claim 1, including a plurality of actuators grouped together on a stand of the structure.

3. A structure according to claim 1, wherein the casing presents folds at the variable-geometry segment that are substantially perpendicular to the central axis of the casing so as to allow the variable-geometry segment to have a length differential on either side of the central axis while keeping the cross-section of the variable-geometry segment constant.

4. A structure according to claim 3, wherein the folds are of annular shape and comprise portions that are stitched together along two lines of stitching that extend symmetrically on either side of the central axis, and free portions extending symmetrically on either side of the central axis.

5. A structure according to claim 4, wherein the end of the cable is connected to a free portion of a fold in such a manner that traction exerted by the actuator on the cable causes folding of the fold portion to which the cable is connected.

6. A structure according to claim 1, wherein the cable runs along the casing and at least one guide element for guiding the cable is fastened to the casing.

7. A structure according to claim 5, wherein a cable is connected to each fold, the cables having ends connected to rings fastened to the free portions of the folds and at least one of the cables is engaged in two adjacent rings in order to form a pulley system.

8. A structure according to claim 7, wherein at least one of the rings slidably receives at least another of the cables.

9. A structure according to claim 7, wherein the variable-geometry segment has n folds and the deformation means associated with said variable-geometry segment comprise a single actuator connected to n cables, each connected to a respective fold, the fold that is the furthest away from the actuator being connected to the corresponding cable by a k-strand pulley system and each of the other folds being connected to the corresponding cable via a respective pulley system having a number of strands that is incremented by 1 on going from the fold adjacent to a first end of the variable-geometry segment to the fold adjacent to a second end of the variable-geometry segment so as to reach n+k strands for said fold.

10. A structure according to claim 1, including at least one device for detecting the curvature of at least one variable-geometry segment.

11. A structure according to claim 10, wherein the detection device comprises at least an optical fiber extending parallel to a mean line of the variable-geometry segment and having one end connected to a transmitter that transmits a light beam and an opposite end connected to a photodetector connected to a measurement unit for measuring at least one characteristic of the light beam.

12. A structure according to claim 11, wherein the characteristic of the light is intensity.

13. A structure according to claim 1, wherein the casing presents a central axis along which there are defined at least one fixed-geometry segment and the variable-geometry segment.

14. A structure according to claim 13, wherein the fixed-geometry segment includes at least one bifurcation.

15. A structure according to claim 14, wherein the fixed-geometry segment forms a closed loop.

16. A structure according to claim 1, wherein the variable-geometry segment is arranged so as to curve through a maximum angle of not less than about 90°.

17. A structure according to claim 1, wherein the casing comprises a leaktight inner chamber covered by an inextensible fabric.

18. A robot arm comprising at least an articulated structure in accordance with claim 1.
